(19) United States
(12) Patent Application Publication
(10) Pub. No.: US 2012/0236252 A1
(43) Pub. Date: Sep. 20, 2012

(54) NOSE PAD FOR EYEGLASSES

(76) Inventor: CHIH-HUNG WANG, TAINAN CITY (TW)

(21) Appl. No.: 13/304,764

(22) Filed: Nov. 28, 2011

(30) Foreign Application Priority Data
Mar. 14, 2011 (TW) 100204500

(51) Int. Cl. G02C 5/12

(52) U.S. Cl. 351/139

(57) ABSTRACT

A nose pad structure for eyeglasses comprises a pad arm made of a hardly restorable material with deformable property; and an overcoat layer over-molded integrally with the pad arm. The overcoat layer has a transverse nose bridge portion and two nose pad portions located at the left and the right sides. The transverse nose bridge portion is provided with a joint hole penetrating through the overcoat layer and at least a jut portion. In this manner, the nose pad structure is simple in manufacturing process and can be adjusted according to whether the nose pads fit comfortably on user's nose bridge. The multi-point positioning design of the joint hole and the jut portion can prevent the nose pads from wavering and loosening and even falling off.

### BACKGROUND OF INVENTION

1. Field of the Invention

The present invention relates to a nose pad structure for eyeglasses, more particularly to an eyeglass nose pad structure enabling adjustment on its angle and location according to the difference of wearer's nose bridge structure, and assembly on the frame in simple and stable manner.

2. Brief Description of the Prior Art

Eyeglasses are normally used for vision correction and eye protection against damage from ultraviolet light or foreign matters such as sandy wind. Generally, nose pad structure for eyeglass is provided at the middle bridge portion of the frame so that eyeglasses can be supported stably by the nose pad structure on wearer's nose bridge in addition to the placement of temple arms over the ears in eyeglass wearing. Thus, eyeglasses can be supported on the nose bridge in equipoise by both the temple arms and the nose pad structure.

Usually, there are three different type of manufacturing for conventional nose pad structure: (A) the nose pads are integrally formed with the frame in injection molding process; (B) the nose pads, formed individually into left and right nose pads by hard plastic or rubber, are assembled at the ends of pad arms extending from the bridge portion of the frame; (C) the independently formed nose pads are assembled directly on the corresponding locations on the frame. The nose pads (A) are simple in manufacturing but cannot be adjusted according to whether the nose pads fit comfortably on user's nose bridge. The nose pads (B) can replace nose pad parts according to different wearer's nose bridge structure, but the pad arms extending from the frame or the frame is easily deformed or even the structural strength and the lifetime of the frame is deteriorated when conducting adjustment; the nose pads (C) can avoid structural strength deterioration of the frame, but due to lack of pad arms the angle of the nose pads cannot be adjusted according to whether the nose pads fit comfortably on user's nose bridge, or the nose pads are easily subjected to wavering or loosening or even falling off.

In view of the above disadvantage, the inventor of the present invention provides a novel eyeglass nose pad structure with simplicity in manufacturing, convenience in assembly and stability in wearing, according to the research and improvement directed to solve the inconvenience and disadvantages of the conventional nose pad structure and based on his proficient experience in R&D and manufacturing in relevant field.

### SUMMARY OF INVENTION

The object of the present invention is to provide a nose pad structure for eyeglasses, comprising a pad arm made of a hardly restorable material with deformable property and having a reverse U shape with a bigger opening; and an overcoat layer overmolded integrally with the pad arm, the overcoat layer having a transverse nose bridge portion and two nose pads located at left and right sides enabling angle adjustment by wearer; the transverse nose bridge portion being provided with a joint hole penetrating through the overcoat layer and at least one jut portion, the nose pads being able to be assembled in more stable manner by multi-point positioning. In this manner, the nose pad structure is simple in manufacturing and can be adjusted according to whether the nose pads fit comfortably on user's nose bridge. The multi-point positioning design of the joint hole and the jut portion can prevent the nose pads from wavering and loosening and even falling off.

### BRIEF DESCRIPTION OF THE DRAWINGS

FIG. 1 is a perspective view showing the appearance of the embodiment of the present invention.

FIG. 2 is a sectional view showing the embodiment of the present invention.

FIG. 3 is a schematic view showing the assembly state between the eyeglass nose pad structure of the embodiment of the present invention and the frame of eyeglasses.

FIG. 4 is a perspective view showing the appearance of another embodiment of the present invention.

FIG. 5 is a schematic view showing the assembly state between the eyeglass nose pad structure of another embodiment of the present invention and the frame of eyeglasses.

FIG. 6 is a schematic view showing the state of adjusting the pad arm when the eyeglasses having the nose pad structure of the present invention is worn.

### DETAILED DESCRIPTION OF PREFERRED EMBODIMENTS

The objects, the technical contents and the expected effect of the present invention will become more apparent from the detailed description of the preferred embodiments in conjunction with the accompanying drawings.

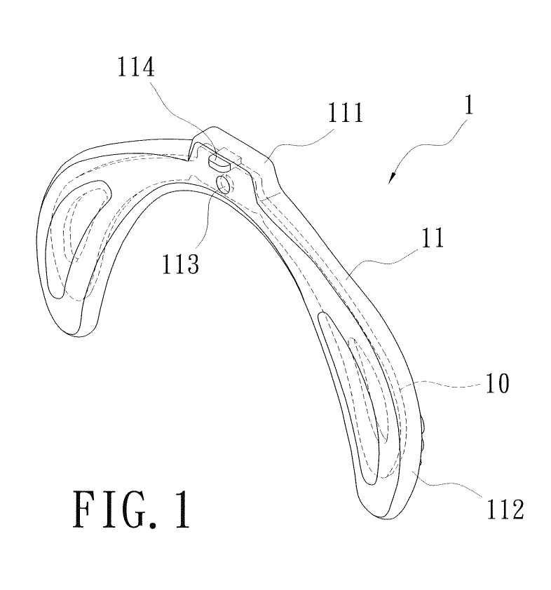

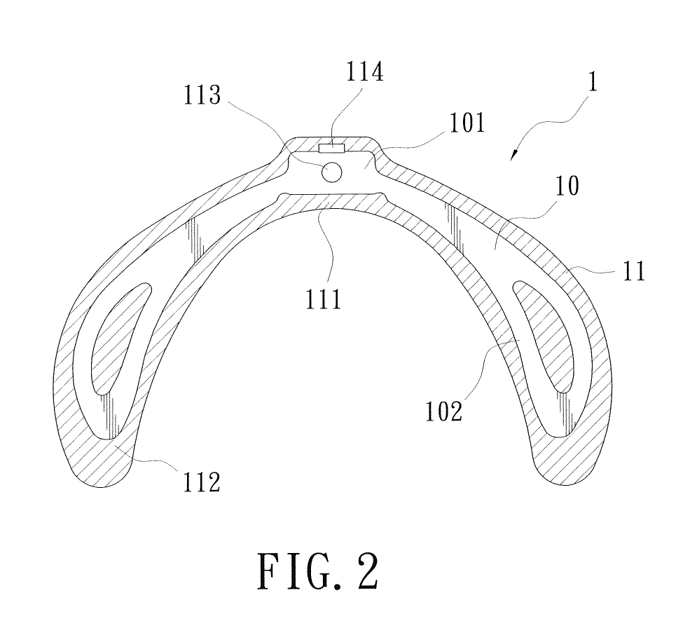

Referring to FIGS. 1 to 3, the eyeglass nose pad structure (1) of the present invention is disposed at the middle bridge portion of the eyeglass frame (2). The eyeglass nose pad structure (1) comprises a pad arm (10) made of a hardly restorable material with deformable property and having a reverse U shape with a bigger opening. The pad arm (10) has left and right side portions (102) and a coupling portion (101) connected therebetween. An overcoat layer (11) is overmolded integrally with the pad arm (10), and the overcoat layer (11) has two nose pad portions (112) for fitting on the wearer's nose bridge and a transverse bridge portion (111) connecting the two nose pad portions (112). A joint hole (113) is provided on the transverse bridge portion (111), and at least one jut portion (114) is provided on the transverse bridge portion (111) and is engaged in a corresponding recess (21) of the frame (2). The jut portion (114) can be either integrally extended from the coupling portion (101) of the pad arm (10) or integrally formed with the transverse bridge portion (111) of the overcoat layer (11) by injection molding.

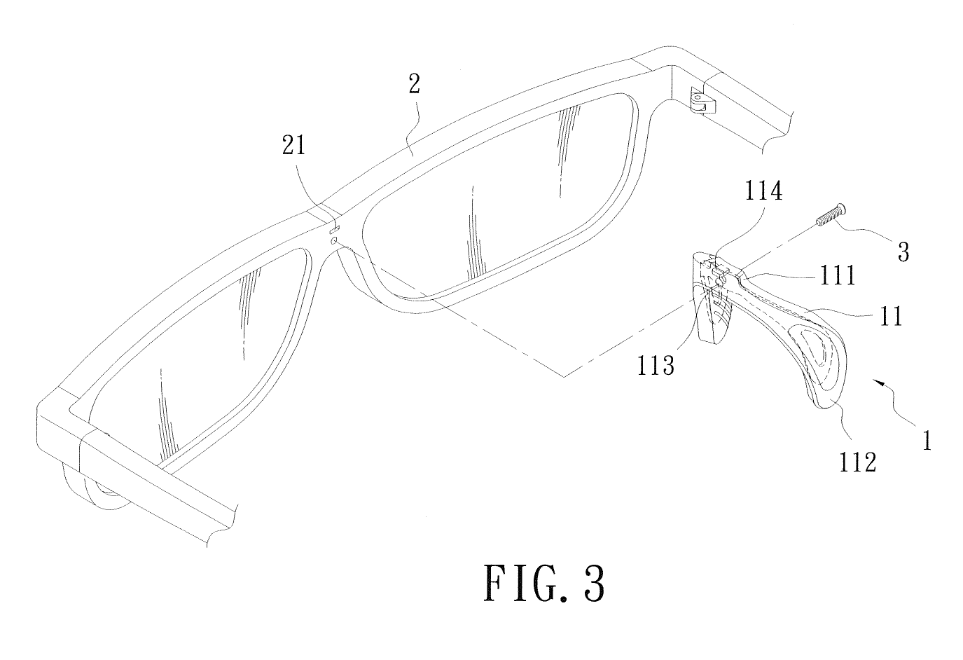

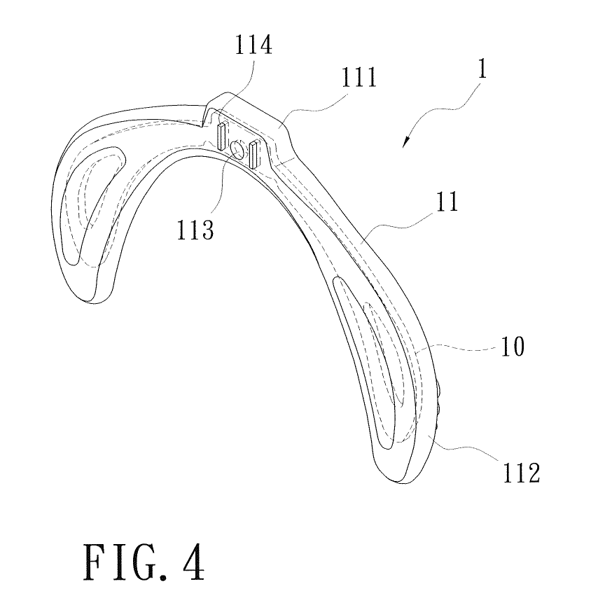

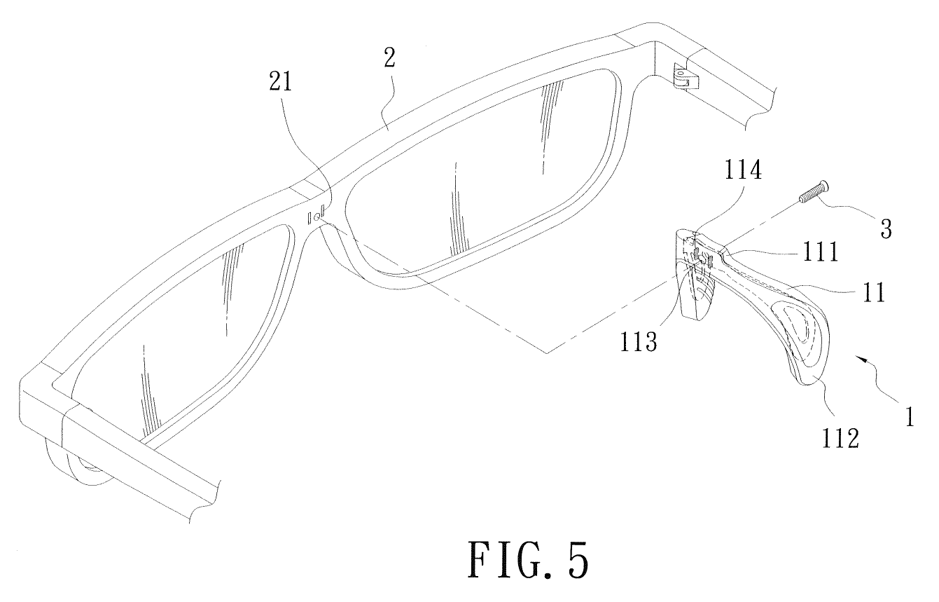

When the eyeglass nose pad structure (1) is assembled on the frame (2), as shown in FIG. 3, a screw (3) is used to penetrate the joint hole (113) so as to fasten the nose pad structure (1) at the middle bridge portion of the frame (2) firmly, simultaneously the jut portion (114) of the nose pad structure (1) is engaged in a corresponding recess (21) of the frame (2), so that a multi-point locking is formed to avoid the screw (3) from wavering or loosening or even falling off easily. Alternatively, the jut portion (114) can be provided at the left and the right sides of the joint hole (113) instead of the upper and the lower sides of the joint hole (113), as shown in another embodiment depicted in FIGS. 4 and 5.

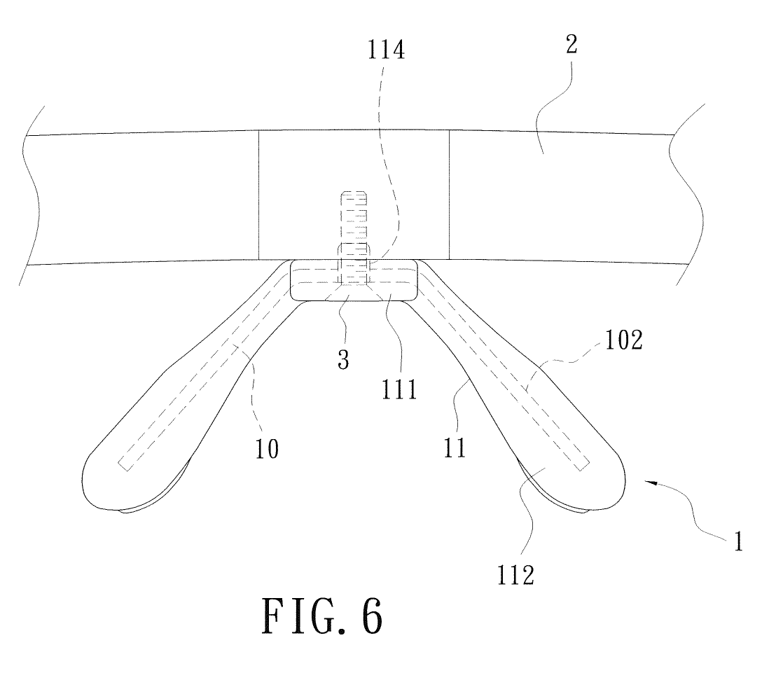

When the eyeglasses having the nose pad structure (1) of the present invention is worn on wearer, as shown in FIG. 6, the two side portions (102) of the pad arm (10) can be bent into appropriate angles and locations according to different nose bridge structures of users, so the nose pad portions (112) can be fitted on the nose bridge of wearer in such a manner as to allow the wearer feeling comfortable.

Based on foregoing, the present invention has the advantages listed below when compared with prior art.

1. Conventionally, a left and a right nose pad portions are firstly made of hard plastic or rubber material and then the left and right nose pad portions are assembled on the frame of eyeglasses. Comparing to the above prior art, the overcoat layer formed on the pad arm by integral overmolding technology can allow user to adjust the two side portions according to the requirement of user so as to obtain comfortable fitting between the middle bridge portion of the nose pad structure and the nose bridge of user, in addition to the simplicity in manufacturing process of the nose pad structure.

2. Comparing to the projection or recess to be assembled in corresponding positions on the frame in prior art, the joint hole and at least one jut portion in the present invention can allow the fastening of the screw become more secure. In addition, the multi-point locking can avoid the screw from wavering or loosening or even falling off easily.

Summing up above, the eyeglass nose pad structure of the present invention can achieve expected effects by the embodiments disclosed above. Moreover, this invention is not opened to the public before submission of application so as to conform entirely to the regulations and demands of the Patent Law.

It is noted that the above drawings and description are the preferred embodiments of the present invention only, not used to limit the scope of the present invention. Any equivalent variation or modification conducted by the person skilled in the art without departing from the spirit and scope of the present invention are still considered to be within the scope of the present invention.

What is claimed is:

1. A nose pad structure for eyeglasses, which is disposed at the middle bridge portion of the frame of the eyeglasses, comprising:
a pad arm made of a hardly restorable material with deformable property and having a reverse U shape with a bigger opening, said pad arm having a left and a right side portions and a coupling portion connected therebetween;
an overcoat layer overmolded integrally with said pad arm, said overcoat layer having two nose pad portions for fitting on wearer's nose bridge and a transverse nose bridge portion connecting between said two nose pad portions;
a joint hole provided on said transverse nose bridge portion, a screw for engaging with said joint hole being used to fasten with said frame of eyeglasses securely; and
at least one jut portion provided on said transverse nose bridge portion, said jut portion being engaged in a corresponding recess of said frame.

2. The nose pad structure for eyeglasses as claimed in claim 1, wherein said jut portion is integrally extended from the coupling portion of said pad arm.

3. The nose pad structure for eyeglasses as claimed in claim 1, wherein said jut portion is integrally formed with a transverse bridge portion of said overcoat layer by injection molding.

4. The nose pad structure for eyeglasses as claimed in claim 1, wherein said jut portion is provided at either the upper and the lower sides or the left and the right sides of said joint hole.

5. The nose pad structure for eyeglasses as claimed in claim 2, wherein said jut portion is provided at either the upper and the lower sides or the left and the right sides of said joint hole.

6. The nose pad structure for eyeglasses as claimed in claim wherein said jut portion is provided at either the upper and the lower sides or the left and the right sides of said joint hole.
